(19) United States
(12) Patent Application Publication
(10) Pub. No.: US 2016/0283103 A1
(43) Pub. Date: Sep. 29, 2016

(54) ELECTRONIC DEVICES PROVIDED WITH TOUCH DISPLAY PANEL

(71) Applicant: JVC KENWOOD Corporation, Yokohama-shi (JP)

(72) Inventor: Shigehiro MIZUNO, Yokohama-shi (JP)

(73) Assignee: JVC KENWOOD Corporation

(21) Appl. No.: 15/077,956

(22) Filed: Mar. 23, 2016

(30) Foreign Application Priority Data
Mar. 26, 2015 (JP) 2015-064911

(51) Int. Cl. G06F 3/0488

(52) U.S. Cl. CPC G06F 3/04883

(57) ABSTRACT

A touch display panel on a surface of an electronic device. A sensor group is provided in a neighborhood of the touch display panel. An estimation unit estimates a position of a wrist of a user by referring to a detection region in which detection by the sensor occurs. A setting sets a range of performance of a finger of the user on the touch display panel in accordance with a direction of a vector from the position of the wrist of the user to a center of the detection region. A processing unit performs a touch-panel implemented process in accordance with the range of performance set by the setting unit.

### CROSS-REFERENCE TO RELATED APPLICATION

This application is based upon and claims the benefit of priority from the prior Japanese Patent Application No. 2015-64911, filed on Mar. 26, 2015, the entire contents of which are incorporated herein by reference.

### BACKGROUND

1. Field

The present invention relates to an electronic device and, more particularly, to an electronic device provided with a touch display panel.

2. Description of the Related Art

More and more electronic devices such as cell phones, Ultra-Mobile PC's (UMPC), digital cameras, and portable game devices are now equipped with displays having large display ranges to display video. In association with an increase in the display range, the detection range on the touch panel in these electronic devices is also increased. When the arrangement of icons on the touch panel of an electronic device is stationary, the user may find it difficult to control the electronic device by holding the device with a single hand. To address this issue, icons are displayed in a range desired by the user so as to improve operability (see, for example, patent document 1).
[patent document 1] Japanese Patent Application Publication 2011-86036

Touch panels are also provided in electronic devices such as on-vehicle navigation terminal devices. The orientation of a touch panel provided in a cell phone is not stationary and is moved/rotated at will so as to be held in front of the user. Meanwhile, the touch panel provided in an on-vehicle navigation terminal device is fixed at a particular place in the vehicle and is not provided in front of the user. Further, the touch panel may be controlled with the hand that is not the dominant hand of the user. Therefore, the touch panel provided in an on-vehicle navigation terminal device is difficult to control than the touch panel provided in a cell phone.

### SUMMARY

To address the aforementioned issue, an electronic device comprises: a touch display panel; a sensor provided in a neighborhood of the touch display panel; an estimation unit that estimates a position of a wrist of a user by referring to a detection region in which detection by the sensor occurs; a setting unit that sets a range of performance of a finger of the user on the touch display panel in accordance with a direction of a vector from the position of the wrist of the user to a center of the detection region; and a processing unit that performs a touch-panel implemented process in accordance with the range of performance set by the setting unit.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows a vehicle interior in which an electronic device according to an embodiment is mounted from behind;

FIG. 2 is a front view of the electronic device of FIG. 1;

FIG. 3 shows the configuration of the electronic device of FIG. 2;

FIG. 4 shows an outline of the process in the sensor of FIG. 2;

FIG. 5 shows an outline of the process in the estimation unit of FIG. 2;

FIG. 6 shows a data structure in the database of FIG. 2;

FIG. 7 shows another outline of the process in the estimation unit of FIG. 2;

FIG. 8 shows ranges of performance set by the setting unit of FIG. 2;

FIG. 9 shows an outline of the process in the setting unit of FIG. 2;

FIG. 10 shows an outline of the process in the setting unit of FIG. 2;

FIG. 11 shows an arrangement of buttons adjusted by the image generation unit of FIG. 2;

FIG. 12 shows an alternative arrangement of buttons adjusted by the image generation unit of FIG. 2; and

FIG. 13 shows an outline of coordinate conversion by the conversion unit.

### DETAILED DESCRIPTION

The invention will now be described by reference to the preferred embodiments. This does not intend to limit the scope of the present invention, but to exemplify the invention.

A brief summary will be given before describing the invention in specific details. An embodiment described hereinafter relate to an electronic device mounted on a vehicle and provided with a touch display panel. Inductive touch panels, capacitive touch panels, etc. have been used in various electronic devices. A user can select an operation by touching a button etc. displayed on the screen of the touch panel with a finger. The user flicks (slides a finger) or pinches in or pinches out (enlarges, reduces, or rotates the screen using a combination of movements of fingers) to control the device.

As mentioned before, in the case that the electronic device is an on-vehicle navigation terminal device, the touch panel is substantially fixed in an upright position so that the user may find it difficult to control the device, unlike the case of cell phones. Further, in comparison with the operation of merely touching a button, the operation of sliding a finger or using multiple fingers may extend into a range that cannot be normally reached by moving the wrist or finger. This forces the user to change the angle of the arm from the elbow up or take an unnatural posture. For this reason, it is desired to make a flick operation or a pinch-in/pinch-out operation on an on-vehicle navigation terminal device easy.

To address this issue, the electronic device according to the embodiment is configured such that a plurality of sensors are provided in a frame surrounding the touch display panel so as to detect the hand of the user accessing the touch display panel, using the plurality of sensors. Further, the electronic device stores a database related to the width of human hand. By checking the width information on the detected hand against the database, the position of the wrist of the user is estimated. Further, the electronic device sets a range of performance of the finger by referring to the wrist position. The electronic device displays a screen in which graphical user interface (GUI) components are arranged or makes a determination whether a flick operation or a pinch-in/pinch-out operation takes place, by considering the range of performance thus set. By estimating the wrist position, the device sets the range of performance of the finger that does not straining the elbow joint or wrist joint while the wrist is fixed.

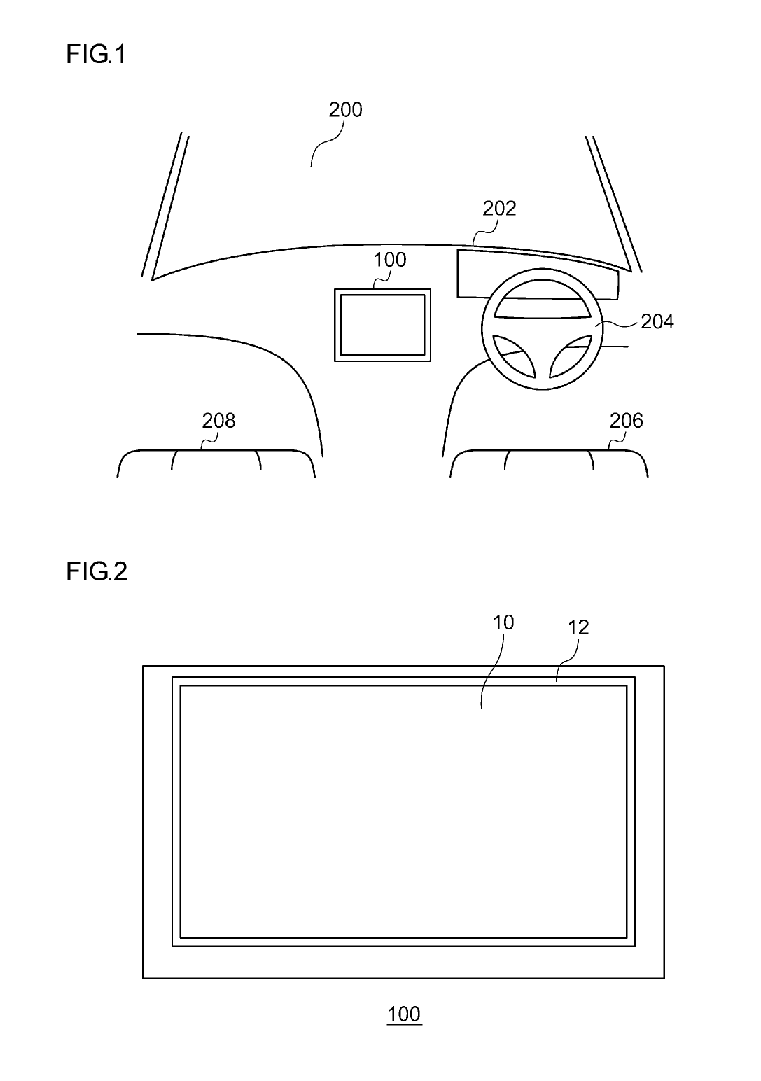

FIG. 1 shows a vehicle interior in which an electronic device 100 according to the embodiment is mounted from behind. In the font part of the vehicle interior, a driver's seat 206 is provided on the right, a front passenger's set 208 is provided on the left, and a handle 204 is provided in front of the driver's seat 206. FIG. 1 shows the handle 204 and the driver's seat 206 provided on the right but they may be provided on the left. An instrument panel 202 is provided in front of the handle 204. A front glass 200 is provided in front of the instrument panel 202. Moreover, the electronic device 100 is provided beside the handle 204 (e.g., in the center console on the left. The electronic device 100 is an on-vehicle navigation terminal device and an image of a car navigation system is displayed on the screen of the electronic device 100.

FIG. 2 is a front view of the electronic device 100. The electronic device 100 includes a touch display panel 10 and a sensor group 12 (sensors). The touch display panel 10 is provided on the front side of the electronic device 100 and is provided with a display function for presenting information to the user and a touch panel function for determining a position touched by the user for input and a duration of the touch. A publicly known technology may be used for the touch display panel 10 so that a description thereof is omitted.

The sensor group 12 is provided to surround the touch display panel 10 from outside. The sensor group 12 is configured by arranging a plurality of sensors in the shape of a frame. The sensor group 12 detects the hand or finger of the user controlling the touch display panel 10. The sensor group 12 may not surround the touch display panel 10 from outside. For example, the sensors may be arranged only along the right edge of the touch display panel 10. In this case, the sensor group 12 detects the hand of the driver instead of all users. The sensor group 12 may be provided adjacent to the touch display panel 10 or in the neighborhood of the touch display panel 10.

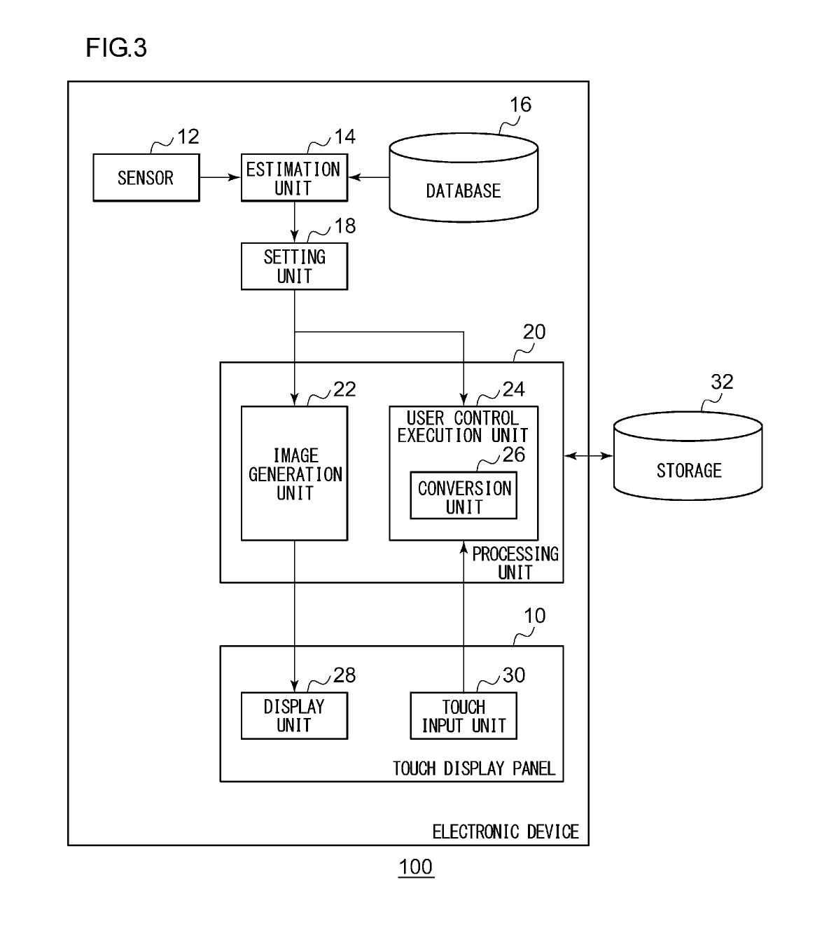

FIG. 3 shows the configuration of the electronic device 100. The electronic device 100 includes the touch display panel 10, the sensor group 12, an estimation unit 14, a database 16, a setting unit 18, and a processing unit 20. The processing unit 20 includes an image generation unit 22 and a user control execution unit 24. The user control execution unit 24 includes a conversion unit 26. The touch display panel 10 includes a display unit 28 and a touch input unit 30. Further, a storage 32 is connected to the electronic device 100.

As shown in FIG. 2, the sensor group 12 is formed in the shape of a frame and includes an arrangement of a plurality of sensors at equal intervals. These sensors detect an object immediately above, if any. Any sensor may be used for each of the plurality of sensors so long as it is capable of detecting that a finger or hand reaches the touch display panel 10. For example, an infrared sensor may be used. The infrared sensor is composed of a light emitting unit that sends infrared light and a light receiving unit arranged in alignment with the light emitting unit. When the finger or hand passes immediately above the infrared sensor, the infrared light sent from the light emitting unit is blocked and reflected by the finger or hand. The light receiving unit detects the finger or hand by receiving the reflected infrared light. A microwave sensor may be used instead of the infrared sensor. In this case, the microwave is transmitted and a determination is made as to whether the finger or hand is immediately above by receiving the microwave that changes in response to the access by the finger or hand.

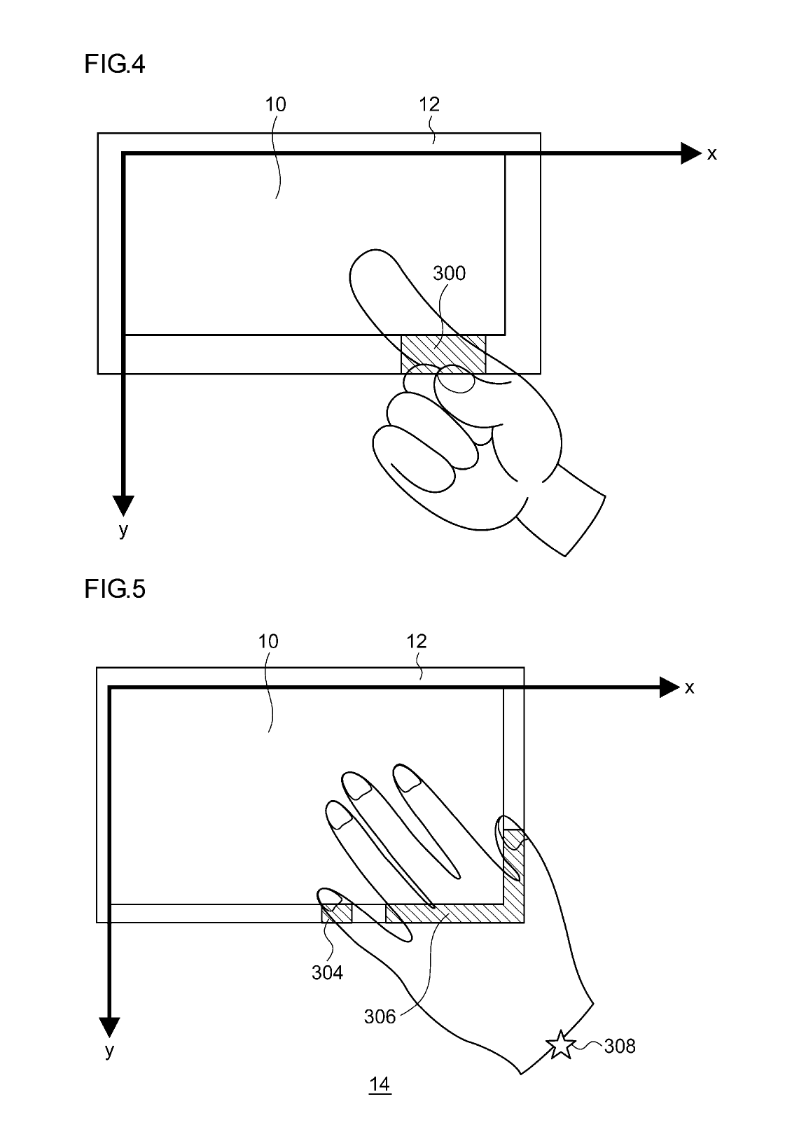

The details of the detection process will be described with reference to FIG. 4. FIG. 4 shows an outline of the process in the sensor group 12. As in FIG. 2, the sensor group 12 is arranged to surround the touch display panel 10. As shown in the figure, it will be assumed that a finger accesses the touch display panel 10 from outside the sensor group 12. As mentioned before, one or more sensors of the sensor group 12 that are arranged in a first detection region 300 detect the finger. Therefore, the direction in which the finger accesses is identified by identifying the position of the first detection region 300 in which the one or more sensors that detected the finger are arranged. The width of the finger passing over the sensor group 12 is identified by referring to the size of the first detection region 300, i.e., the number of sensors detecting the finger. Reference is made back to FIG. 3. The sensor group 12 outputs the position of the one or more sensors detecting the object to the estimation unit 14. This is equivalent to outputting information on the direction of access by the detected object and the width of the object.

The estimation unit 14 estimates the position of the wrist of the user by referring to the result of detection by the sensor group 12, i.e., the information on the direction of access by the object and the width of the object. The estimation process will be described by using FIG. 5. FIG. 5 shows an outline of the process in the estimation unit 14. As in FIG. 4, the figure shows the touch display panel 10, the sensor group 12, and the hand of the user. As shown in the figure, an open hand of the user is located above the sensor group 12. Therefore, the hand is detected in a second detection region 304 and a third detection region 306 of the sensor group 12. The estimation unit 14 of FIG. 3 acquires the wrist position corresponding to the result of detection by the sensor group 12 (e.g., the combination of the second detection region 304 and the third detection region 306). Reference is made back to FIG. 3.

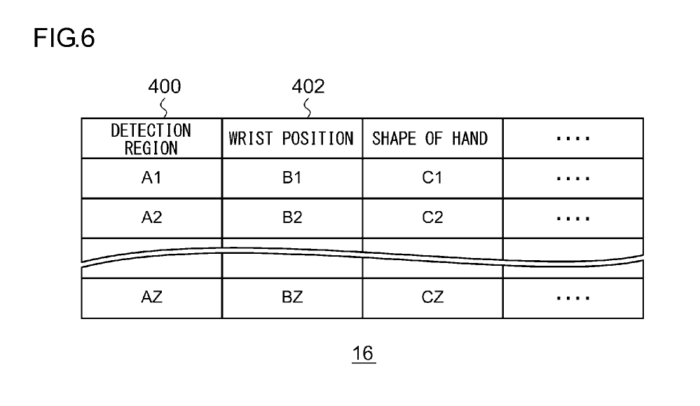

The database 16 stores a table that maps the wrist position to each of a plurality of patterns of results that can be detected by the sensor group 12. FIG. 6 shows a simplified data structure in the database 16. As shown in the figure, the database 16 includes a detection region column 400 and a wrist position column 402. The detection region column 400 lists the results that can be detected by the sensor group 12. The results that can be detected by the sensor group 12 are positions expected to be detected by the sensor group 12. The first detection region 300 of FIG. 4 or the combination of the second detection region 304 and the third detection region 306 of FIG. 5 may be listed. The database 16 stores a plurality of patterns determined by a plurality of items including the shape of the hand (the size of the hand or the open/closed state of the hand), the position of the user relative to the electronic device 100 (whether the device is above, immediately beside, or below the waist of the user), or the direction from which the user controls the electronic device 100 (right or left).

In this case, various directions in which the finger or hand accesses are assumed and detection regions determined by the directions are included in the detection region column 400. In other words, the detection region column 400 include the patterns of detection by the sensors occurring when the user reaches out, from left or right, the hand from the driver's seat to the touch display panel 10 provided toward the center of the vehicle. The wrist position relative to the finger or hand located at the detection region is identified by referring to the length related to the human hand (e.g., the average finger width of fingers or average width of the back of the hand of adults). The wrist position thus identified is included in the wrist position column 402. Referring to FIG. 5, the wrist position 308 is mapped to the combination of the second detection region 304 and the third detection region 306. Reference is made back to FIG. 3.

Of the plurality of patterns stored in the detection region column 400 of the database 16, the estimation unit 14 identifies a pattern closest to the detection result and retrieves the wrist position mapped to the pattern from the database 16. In order to track a movement of the user to extend or retract the hand, the estimation unit 14 receives detection results from the sensor group 12 at predetermined time intervals and estimates the wrist position sequentially, by referring to the received detection results. The estimation unit 14 outputs the estimated wrist position to the setting unit 18.

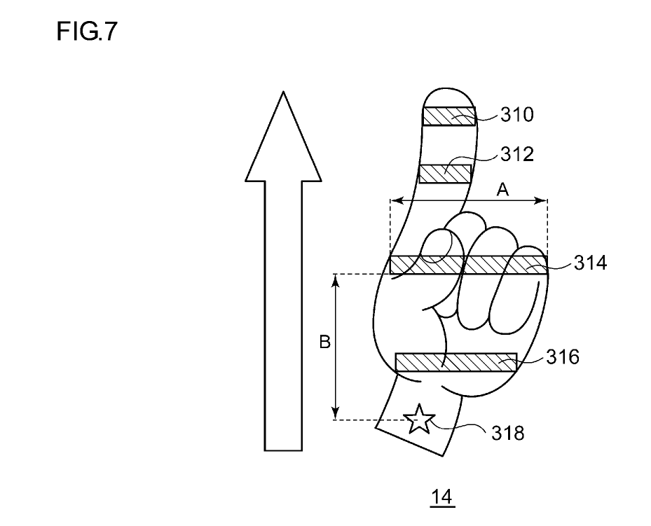

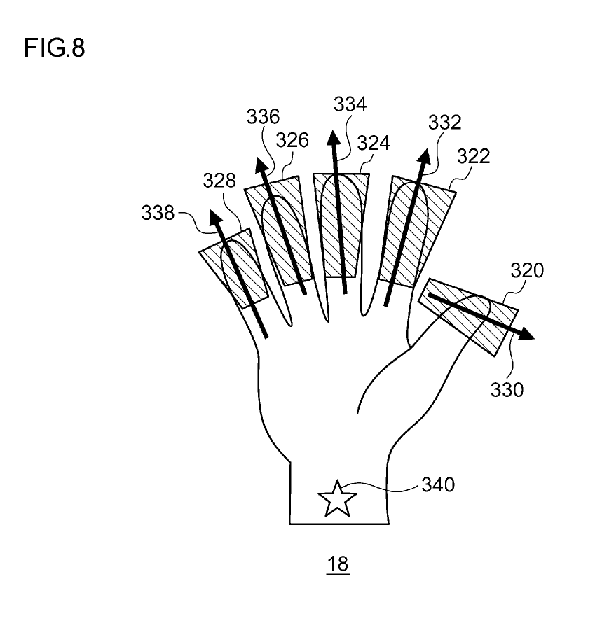

It is assumed above that the wrist position is estimated from the detection result by referring to the database 16, using the absolute one-to-one relationship between the detection result and the wrist position (hereinafter, such estimation will be referred to as “absolute estimation”). Meanwhile, the position of a portion in the hand (e.g., the position of the base of a finger) may be relatively estimated from a time-dependent change in the detection result so as to estimate the wrist positon from the position of the base of the finger (hereinafter, such estimation will be referred to as “relative estimation”). In other words, the estimation unit 14 monitors the time-dependent change in the detection result in the sensor group 12 and estimates the wrist position by referring to the peak value of the detection results. The process will be described in further details by using FIG. 7.

FIG. 7 shows another outline of the process in the estimation unit 14. The hand is moving in the direction indicated by the arrow in the figure. It is assumed that the tip of the index finger accesses the sensor group 12 and the touch display panel 10 (not shown) first, followed by other parts of the hand. Therefore, the sensor group 12 detects a first position 310 first and then detects a second position 312. A third position 314, a fourth position 316, a wrist position 318 are detected sequentially. Associated with this, the estimation unit 14 acquires the first position 310, the second position 312, the third position 314, and the fourth position 316 in the stated order. In this process, the width of the object is increased continuously as far as the base of the finger characterized by the largest width. Beyond the base of the finger, the width of the object is decreased. The estimation unit 14 selects the peak of the acquired values (in this case, the width of the the third position 314) as the width of the base of the finger. The estimation unit 14 also stores the proportion between the width “A” of the base of the finger and the distance “B” from the base of the finger to the wrist, and derives the wrist position corresponding to the third position 314 by referring to the proportion. Further, if the fourth position 316 is currently detected, the estimation unit 14 modifies the wrist position by referring to the ratio between the width of the third position 314 and the width of the fourth position 316. Reference is made back to FIG. 3.

The setting unit 18 receives the wrist position estimated by the estimation unit 14. The wrist position may be derived by absolute estimation or relative estimation. The setting unit 18 sets a range of performance of the finger of the user on the touch display panel 10 by referring to the wrist position estimated by the estimation unit 14. Thus, the range performance in which the user can move the hand without experiencing stress is set in accordance with the result of detection by the sensor group 12.

FIG. 8 shows ranges of performance set by the setting unit 18. It is assumed that the wrist is located at a wrist position 340. The figure shows A1 range 320, A2 range 322, A3 range 324, A4 range 326, A5 range 328, V1 vector 330, V2 vector 332, V3 vector 334, V4 vector 336, and V5 vector 338 defined for the respective fingers. The A1 range 320, the A2 range 322, the A3 range 324, the A4 range 326, and the A5 range 328 are regions in which the user can move the respective fingers without stressing the wrist, given that the wrist is located at the wrist position 340. Meanwhile, the V1 vector 330, the V2 vector 332, the V3 vector 334, the V4 vector 336, and the V5 vector 338 are directions in which the user can move the respective fingers without straining the wrist, given that the wrist is located at the wrist position 340. The positions of the A1 range 320, etc. and the V1 vector 330 etc. relative to the wrist position 340 are defined based on the average wrist sizes of adults.

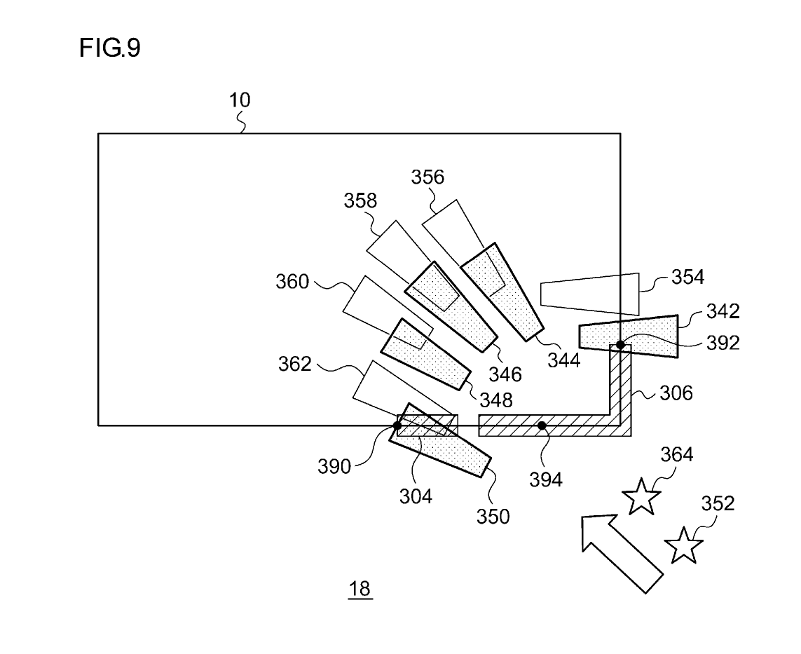

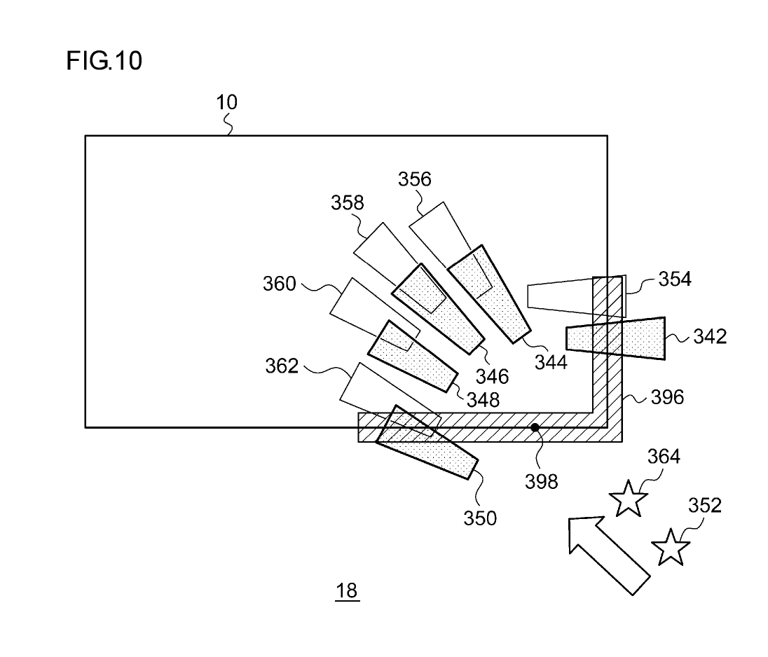

FIG. 9 shows an outline of the process in the setting unit 18. The setting unit 18 receives a first wrist position 352 and then a second wrist position 364 from the estimation unit 14 as estimations of the wrist position. The first wrist position 352 occurs when the hand is located as shown in FIG. 9. The sensor group 12 detects the second detection region 304 and the third detection region 306. Subsequently, the wrist is moved to the second wrist position 364 so that the sensor group 12 detects a fourth detection region 396 as shown in FIG. 10. The setting unit 18 estimates the direction of access by the hand of the user by referring to the first wrist position 352 and the second wrist position 364 received in a time series, and to the centers of the respective detection regions. Referring to FIG. 9, the setting unit 18 first determines the direction of a vector from the first wrist position 352 to a first center 394 of a region from the left end 390 of the second detection region 304 to the upper end 392 of the third detection region 306, and sets a range of performance in accordance with the vector direction. As the wrist is moved as shown FIG. 10 subsequently, the setting unit 18 determines the direction of a vector from the second wrist position 364 to a second center 398 of the fourth detection region 396, and sets a range of performance in accordance with the vector direction. As shown in FIG. 9, the wrist position is aligned with the first wrist position 352 and the second wrist position 364 sequentially. Thus, A140 range 342, A2′ range 344, A3′ range 346, A4′ range 348, and A5′ range 350 are set for the first wrist position 352. Also, A1″ range 354, A2″ range 356, A3″ range 358, A4″ range 360, and A5″ range 362 are set for the second wrist position 364. The A1′ range 342 and the A1” range 354 are derived from modifying the A1 range 320 in accordance with the direction of access and the wrist position. The same is true of the A2′ range 344, the A2″ range 356, etc.

As mentioned above, the A1′ range 342, etc. are ranges in which the user can move a finger without twisting the wrist away from the first wrist position 352. The A1″ range 354, etc. are ranges in which the user can move a finger without twisting the wrist away from the second wrist position 364. The A1′ range 342, the A5′ range, and the A1″ range 354 are set outside the touch display panel 10. Therefore, user control using the thumb or the little finger is difficult for the user to perform. FIG. 9 does not show the V1 vector 330, etc., which are set upon being modified like the A1′ range 342. These vectors are aligned with directions in which the user moves fingers to close the hand. For example, the thumb and the index finger are associated with directions that form a shape of letter V, which is the direction in which the user can move fingers as if to pinch something without moving the wrist. In the case of FIG. 9, the A1″ range 354, the A2″ range 356, the A3″ range 358, the A4″ range 360, and the A5″ range 362 corresponding to a later point of time are ultimately set. Reference is made back to FIG. 3. The setting unit 18 communicates the range of performance thus set to the processing unit 20.

The processing unit 20 runs an application using an application program (hereinafter, simply referred to as “application”) and data stored in the storage 32. The processing unit 20 runs an application implemented by the touch display panel 10 in accordance with the range of performance set by the setting unit 18. For example, the application uses a GUI. The image generation unit 22 generates a screen to run the application and causes the display unit 28 to display the screen thus generated. In particular, the image generation unit 22 adjusts the arrangement of an image that should be displayed on the touch display panel 10 (e.g., GUI components including icons, buttons, etc.) in accordance with the range of performance set by the setting unit 18. This is equivalent to creating a user-friendly screen configuration in accordance with the range of performance.

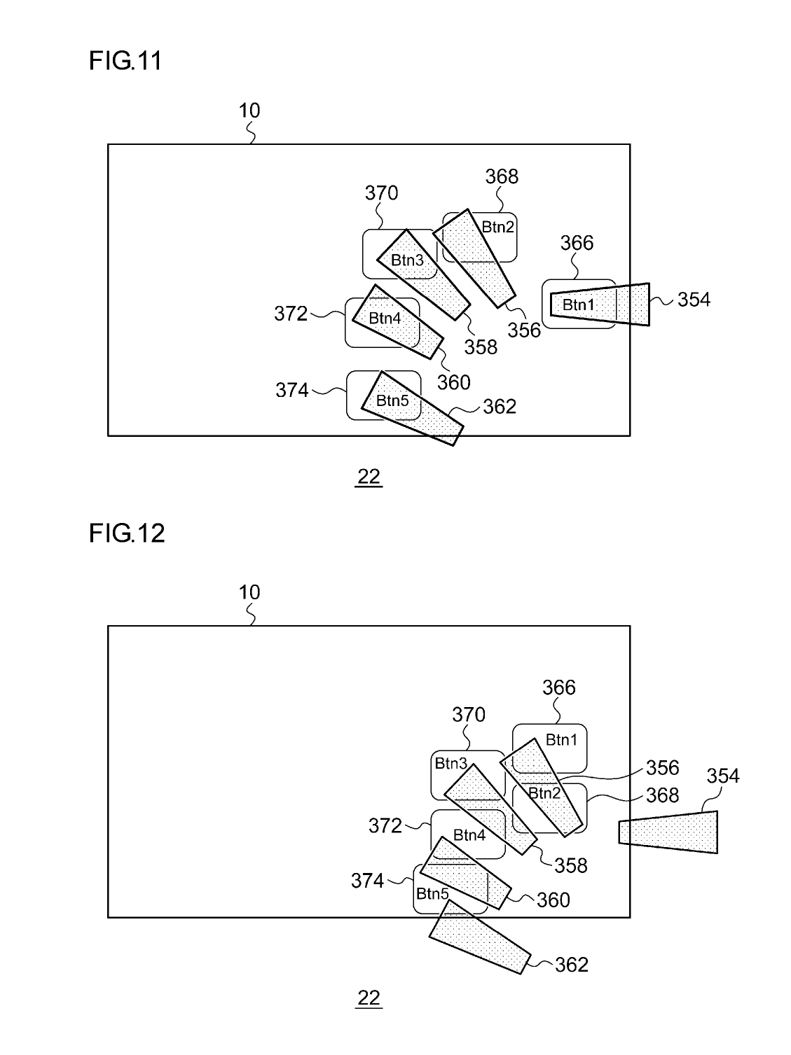

FIG. 11 shows an arrangement of buttons adjusted by the image generation unit 22. The image generation unit 22 receives information on the A1″ range 354 through the A5″ range 362 from the setting unit 18. The image generation unit 22 arranges a first button 366 so as to overlap the A1″ range 354. Further, the image generation unit 22 arranges a second button 368, a third button 370, a fourth button 372, and a fifth button 374 so as to overlap the A2″ range 356, the A3″ range 358, the A4″ range 360, and the A5″ range 362, respectively. The first button 366 through the fifth button 374 are buttons for receiving an instruction for the application from the user. These buttons are positioned so that the user can touch them easily. When the position of the user's hand moves on the touch display panel 10 and the sensor group 12, the arrangement of these buttons are also changed in accordance with the movement. In the drawing, five buttons including the first button 366 through the fifth button 374 are shown. Alternatively, the number of buttons generated by the image generation unit 22 may be smaller than 5.

FIG. 12 shows an alternative arrangement of buttons adjusted by the image generation unit 22. As in FIG. 11, the image generation unit 22 receives information on the A1″ range 354 through the A5″ range 362 from the setting unit 18. However, the A1″ range 354 and the A5″ range 362 are set outside the touch display panel 10. The image generation unit 22 changes the arrangement of the first button 366 and the fifth button 374 that should be superimposed on these ranges so that the buttons are located within the touch display panel 10. The arrangement of other buttons may be changed in accordance with the change in the arrangement of the first button 366 and the fifth button 374. In the case of a screen in which the user is permitted to use a flick operation to slide a finger, the image generation unit 22 may change the angle of GUI components (e.g., a slide bar) as displayed so that the user can flick in a direction in which the finger can be moved. The direction in which the finger can be moved is set by referring to the vector. Reference is made back to FIG. 3.

As described above, the touch display panel 10 is provided with a display function for presenting information to the user, and a touch panel function for determining the position touched by the user for input and a duration of the touch. In this case, the display unit 28 implements the display function and the touch input unit 30 implements the touch panel function. The display unit 28 implements the display function by displaying the execution screen generated by the image generation unit 22. The touch input unit 30 implements the touch panel function by receiving a touch operation of the user performed on the touch display panel 10. A flick operation and a pinch-in/pinch-out operation are included in a touch operation. The touch input unit 30 outputs the detail of the received touch operation to the user control execution unit 24. The display function and the touch panel function may be implemented by publicly known technologies so that a description thereof is omitted.

The user control execution unit 24 receives the detail of operation from the touch input unit 30 and directs the processing unit 20 to run an application in accordance with the detail of operation received. For example, the user control execution unit 24 receives position information indicating the position of touch on the touch display panel 10 and identifies a button located at the position indicated by the position information. The user control execution unit 24 directs the processing unit 20 to perform a process corresponding to the identified button. If the range of performance set by the setting unit 18 is received, the user control execution unit 24 may direct the conversion unit 26 to convert the coordinates from the touch input unit 30 in accordance with the range of performance. The conversion process in the conversion unit 26 will be described later. The processing unit 20 runs an application in accordance with an instruction from the user control execution unit 24.

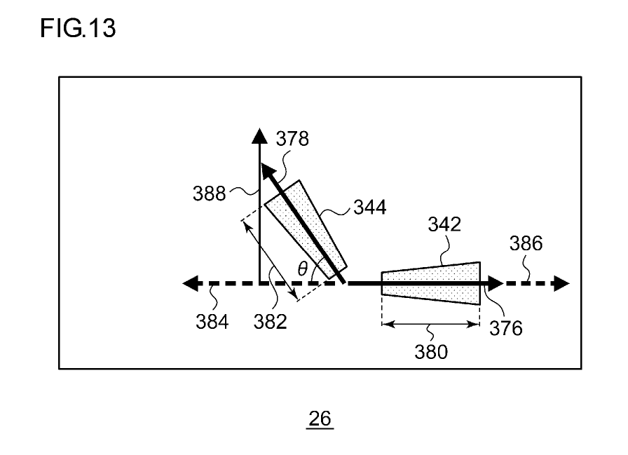

The conversion unit 26 converts the coordinates of a position on the touch display panel 10 touched by the user for input by using a finger, in accordance with the range of performance set by the setting unit 18. The conversion process will be described by using FIG. 13. FIG. 13 shows an outline of coordinate conversion by the conversion unit 26. A screen that permits a pinch-in operation in which the user moves the thumb and the index finger as if to pinch something will be used for the purpose of illustration. A pinch-in operation on an ordinary touch panel is determined by an amount of change in the X and Y coordinates of two points that approach each other on a substantially straight line.

Referring to FIG. 13, a first axis 386 aligned with V1′ vector 376 that represents the direction in which the thumb is moved and a second axis 388 perpendicular to the first axis 386 are defined. The direction in which the index finger is moved is indicated by V2′ vector 378. The amount of movement of the thumb along the V1′ vector 376 is indicated by an L1 distance L1 380, and the amount of movement of the index finger along the V2′ vector 378 is indicated by an L2 distance 382. The V1′ vector 376 and the V2′ vector 378 are not located on a straight line. The V2′ vector 378 is inclined by an angle θ with respect to the first axis 386 aligned with the V1′ vector 376. Therefore, with reference to the first axis 386 and the second axis 388, the amount of change referred to for determination of a pinch-in operation will be the L1 distance 380+the L2 distance 382×cos θ, which means that a determination is made based on an amount of change smaller than the actual amount of change. Therefore, a determination of a pinch-in operation may not be made despite the fact that the thumb and the index finger are moved actually.

The conversion unit 26 receives the V1′ vector 376 and the V2′ vector 378 from the setting unit 18 and so derives the amount of change by summing the amount of movement along the vectors. More specifically, the conversion unit 26 derives the amount of change by adding the L1 distance 380, which is the amount of movement along the V1′ vector 376, and the L2 distance 382, which is the amount of movement along the V2′ vector 378. This is equivalent to dealing with the amount of movement by converting the coordinates represented by using the first axis 386 and the second axis 388 into coordinates represented by the V1′ vector 376 and the V2′ vector 378. In other words, the conversion unit 26 converts the X and Y axes into two axes in a V formation such as the V1′ vector 376 and the V2′ vector 378. This enables an operation desired by the user without requiring the user to gain an amount of movement by expanding the hand forcibly, and only by moving fingers in a range in which the fingers can be moved without moving the wrist. In the case of a flick operation in which the user slides the whole screen, the conversion unit 26 defines an amount of movement in the direction of the V1′ vector 376 or the V2′ vector 378, etc. as an amount of movement in the direction of the X axis or the Y axis. Reference is made back to FIG. 3. The conversion unit 26 outputs the derived amount of change to the user control execution unit 24.

The features are implemented in hardware such as a CPU of a computer, a memory, or other LSI's, and in software such as a program loaded into a memory, etc. The figure depicts functional blocks implemented by the cooperation of these elements. Therefore, it will be obvious to those skilled in the art that the functional blocks may be implemented in a variety of manners by hardware only or by a combination of hardware and software.

According to the embodiment, a touch-panel implemented process is performed by referring to the result of detection by the sensor and in accordance with the range of performance of the user's finger that is set. Therefore, the operability of the touch panel is improved. The range of performance of the user's finger is set by estimating the position of the wrist of the user and referring to the estimated wrist position. This allows setting a range of performance of the finger that can be reached easily at the wrist position. Moreover, even in the case of a touch panel operation in, for example, an on-vehicle device performed with the hand that is not the dominant hand, the user does not need to force himself or herself into an unnatural position and so can reduce the load on the elbow or the wrist. Since the database that maps each of a plurality of detection patterns to a wrist position is stored and the wrist position corresponding to the detection result is acquired from the database, the wrist position can be easily estimated. Further, the time-dependent change in the detection result is monitored and the wrist position is estimated by referring to the peak value in the detection result so that the wrist position is estimated by referring to the relative position. Since the wrist position is estimated by referring to the relative position, the wrist position can be estimated without using the database.

Further, since the arrangement of GUI components is adjusted in accordance with the range of performance, GUI components are arranged at locations that are within the range of performance of the fingers of the hand extended by the user and that can be easily reached by the user for operation, even in the case of a touch panel operation on a fixed screen such as that of an on-vehicle device. Since GUI components are arranged at locations that are within the range of performance of the fingers of the hand extended by the user and that can be easily reached by the user for operation, a use-friendly GUI is provided. Further, in cases where the user extends the hand for operation from outside the front of a screen like that of a fixed screen of an on-vehicle device, GUI components can be arranged in the range of performance of the current finger such that the user is not required to bend the elbow or wrist joint forcibly. Still further, since the coordinates are converted in accordance with the range of performance, a pinch-in operation performed on the whole screen of a device such as an on-vehicle device with a large-size touch panel can be identified without requiring the user to extend fingers forcibly. In the case of a touch panel that allows multiple touches, the range and direction in which fingers can perform without requiring the user to twist the wrist relative to the direction of access by the finger, hand, and wrist to the screen. Therefore, a user-friendly GUI is provided.

Described above is an explanation based on an exemplary embodiment. The embodiment is intended to be illustrative only and it will be obvious to those skilled in the art that various modifications to constituting elements and processes could be developed and that such modifications are also within the scope of the present invention.

In the embodiment, the sensor group 12 and the estimation unit 14 estimate the wrist position on an XY plane parallel to the touch display panel 10 and the setting unit 18 sets the range of performance. Alternatively, the sensor group 12 may measure how far an object is distanced from the surface of the touch display panel 10. In this case, the estimation unit 14 may estimate the wrist position (X, Y, Z) in a 3D space having its origin at an end of the touch display panel 10, and the setting unit 18 may set the range of performance in the 3D space.

What is claimed is:

1. An electronic device comprising:
a touch display panel;
a sensor provided in a neighborhood of the touch display panel;
an estimation unit that estimates a position of a wrist of a user by referring to a detection region in which detection by the sensor occurs;
a setting unit that sets a range of performance of a finger of the user on the touch display panel in accordance with a direction of a vector from the position of the wrist of the user to a center of the detection region; and
a processing unit that performs a touch-panel implemented process in accordance with the range of performance set by the setting unit.

2. The electronic device according to claim 1, wherein
the estimation unit monitors a time-dependent change in the detection region in which detection by the sensor occurs and estimates the position of the wrist by referring to a peak value of detection results.

3. The electronic device according to claim 1, further comprising:
a database that maps the detection region in which detection by the sensor occurs to the wrist position, in a plurality of patterns, wherein
the estimation unit acquires the wrist position corresponding to the detection region from the database.

4. The electronic device according to claim 1, wherein
the processing unit adjusts an arrangement of an image that should be displayed on the touch display panel in accordance with the range of performance set by the setting unit.

5. The electronic device according to claim 2, wherein
the processing unit adjusts an arrangement of an image that should be displayed on the touch display panel in accordance with the range of performance set by the setting unit.

6. The electronic device according to claim 3, wherein
the processing unit adjusts an arrangement of an image that should be displayed on the touch display panel in accordance with the range of performance set by the setting unit.
